(19) United States
(12) Patent Application Publication
(10) Pub. No.: US 2014/0226895 A1
(43) Pub. Date: Aug. 14, 2014

(54) Feature Point Based Robust Three-Dimensional Rigid Body Registration

(71) Applicant: LSI Corporation, San Jose, CA (US)

(72) Inventors: Dmitry Nicolaevich Babin, Moscow (RU); Alexander Alexandrovich Petyushko, Bryansk (RU); Ivan Leonidovich Mazurenko, Khimki (RU); Alexander Borisovich Kholodenko, Moscow (RU); Denis Vladimirovich Parkhomenko, Mytyschy (RU)

(73) Assignee: LSI Corporation, San Jose, CA (US)

(21) Appl. No.: 13/972,349

(22) Filed: Aug. 21, 2013

(30) Foreign Application Priority Data
Feb. 13, 2013 (RU) 2013106319

(51) Int. Cl. G06K 9/00

(52) U.S. Cl. CPC G06K 9/00201
USPC 382/154

(57) ABSTRACT

A method and system for registration of three-dimensional (3D) image frames is disclosed. The method includes receiving two point clouds representing two 3D image frames obtained at two time instances; locating the origins for the two point clouds; constructing two 2D grids for representing the two point clouds, wherein each 2D grid is constructed based on spherical representation of its corresponding point cloud and origin; identifying two sets of feature points based on the two 2D grids constructed; establishing a correspondence between the first set of feature points and the second set of feature points based on a neighborhood radius threshold; and determining an orthogonal transformation between the first 3D image frame and the second 3D image frame based on the correspondence between the first set of feature points and the second set of feature points.

### CROSS-REFERENCE TO RELATED APPLICATIONS

The present application claims priority based on Russian Application No. 2013106319 filed Feb. 13, 2013, the disclosure of which is hereby incorporated by reference in its entirety.

### TECHNICAL FIELD

The present invention relates to the field of image processing and particularly to systems and methods for three-dimensional rigid body registration.

### BACKGROUND

Image registration is the process of transforming different sets of data into one coordinate system. Data may be multiple photographs, data from different sensors, from different times, or from different viewpoints. Registration is necessary in order to be able to compare or integrate the data obtained from these different measurements.

### SUMMARY

Accordingly, an embodiment of the present disclosure is directed to a method for registration of 3D image frames. The method includes receiving a first point cloud representing a first 3D image frame obtained at a first time instance and a second point cloud representing a second 3D image frame obtained at a second time instance; locating a first origin for the first point cloud; locating a second origin for the second point cloud; constructing a first 2D grid for representing the first point cloud, wherein the first 2D grid is constructed based on spherical representation of the first point cloud and the first origin; constructing a second 2D grid for representing the second point cloud, wherein the second 2D grid is constructed based on spherical representation of the second point cloud and the second origin; identifying a first set of feature points based on the first 2D grid constructed; identifying a second set of feature points based on the second 2D grid constructed; establishing a correspondence between the first set of feature points and the second set of feature points based on a neighborhood radius threshold; and determining an orthogonal transformation between the first 3D image frame and the second 3D image frame based on the correspondence between the first set of feature points and the second set of feature points.

A further embodiment of the present disclosure is directed to a method for registration of 3D image frames. The method includes receiving a first point cloud representing a first 3D image frame obtained at a first time instance and a second point cloud representing a second 3D image frame obtained at a second time instance; locating a first origin for the first point cloud; locating a second origin for the second point cloud; constructing a first 2D grid for representing the first point cloud, wherein the first 2D grid is constructed based on spherical representation of the first point cloud and the first origin; constructing a second 2D grid for representing the second point cloud, wherein the second 2D grid is constructed based on spherical representation of the second point cloud and the second origin; identifying a first set of feature points based on the first 2D grid constructed; identifying a second set of feature points based on the second 2D grid constructed; establishing a correspondence between the first set of feature points and the second set of feature points based on a neighborhood radius threshold, wherein the neighborhood radius threshold is proportional to a time difference between the first time instance and the second time instance; and determining an orthogonal transformation between the first 3D image frame and the second 3D image frame based on the correspondence between the first set of feature points and the second set of feature points.

An additional embodiment of the present disclosure is directed to a computer-readable device having computer-executable instructions for performing a method for registration of 3D image frames. The method includes receiving a first point cloud representing a first 3D image frame obtained at a first time instance and a second point cloud representing a second 3D image frame obtained at a second time instance; locating a first origin for the first point cloud; locating a second origin for the second point cloud; constructing a first 2D grid for representing the first point cloud, wherein the first 2D grid is constructed based on spherical representation of the first point cloud and the first origin; constructing a second 2D grid for representing the second point cloud, wherein the second 2D grid is constructed based on spherical representation of the second point cloud and the second origin; identifying a first set of feature points based on the first 2D grid constructed; identifying a second set of feature points based on the second 2D grid constructed; establishing a correspondence between the first set of feature points and the second set of feature points based on a neighborhood radius threshold; and determining an orthogonal transformation between the first 3D image frame and the second 3D image frame based on the correspondence between the first set of feature points and the second set of feature points.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow diagram illustrating a method for registration of two 3D images;

FIG. 2 is an illustration depicting a 2D grid with feature point candidates;

FIG. 3 is an illustration depicting correspondence between feature points identified on two different 2D grids; and

FIG. 4 is a block diagram illustrating a system for registration of two3D images.

### DETAILED DESCRIPTION

Reference will now be made in detail to the presently preferred embodiments of the invention, examples of which are illustrated in the accompanying drawings.

The present disclosure is directed to a method and system for registration of two or more three-dimensional (3D) images. Suppose we have a series of image frames obtained using a 3D-camera (e.g., a time-of-flight camera, a structured light imaging device, a stereoscopic device or other 3D imaging devices), and a rigid object is captured on this series of image frames and that rigid object moves over time. Also suppose that each frame, after certain image processing and coordinate transformations, provides a finite set of points (hereinafter referred to as a point cloud) in a Cartesian coordinate system that represents the surface of that rigid object. Having two of such frames acquired at time T and T+t (not necessarily adjacent by time, which means that t can be much greater than 1/fps where fps is a frame rate of the camera/imager), the method and system is accordance with the present disclosure can be utilized to find an optimal orthogonal transformation between the rigid object captured at time T and T+t.

The ability to obtain such a transformation can be utilized to find out many useful characteristics of the rigid object of interest. For instance, suppose the rigid object is the head of a person, the transformation obtained can help detecting the gaze direction of that person. It is contemplated that various other characteristics of that person can also be detected based on this transformation. It is also contemplated that the depiction of a head of a person as the rigid object is merely exemplary. The method and system is accordance with the present disclosure is applicable to various other types of objects without departing from the spirit and scope of the present disclosure.

In one embodiment, the method for estimating movements of a rigid object includes a feature point detection process and an initial motion estimation process based on a two-dimensional (2D) grid constructed in spherical coordinate system. It is contemplated, however, that the specific coordinate system utilized may vary. For instance, ellipsoidal, cylindrical, parabolic cylindrical, paraboloidal and other similar curvilinear coordinate systems may be utilized without departing from the spirit and scope of the present disclosure.

For two frames obtained at time T and T+t, once the feature points are detected, finding correspondence between such feature points across the two frames allows the transformation between the two frames to be established. Furthermore, in certain embodiments, the threshold utilized for finding the correspondence between the feature points is determined dynamically. Utilizing a dynamic threshold allows rough estimates to be established even between frames obtained with significant time difference t between them.

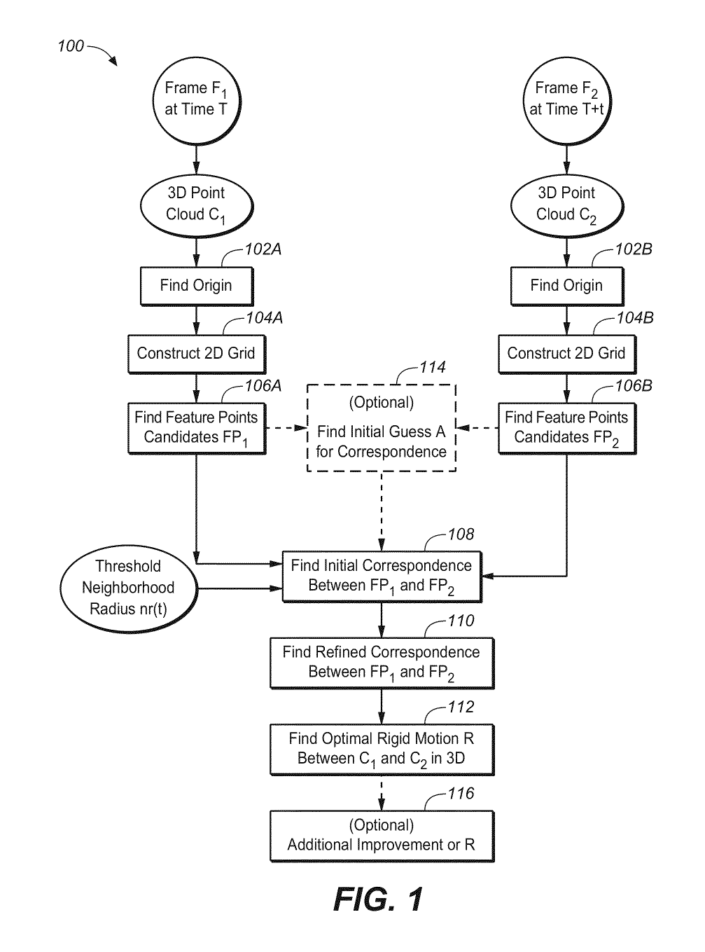

FIG. 1 is a flow diagram depicting a method 100 in accordance with the present disclosure for registration of two 3D image frames obtained at time T and T+t. As illustrated in the flow diagram, the method 100 first attempts to find feature point candidates in each of the frames. A feature point (may also be referred to as interest point) is a terminology in computer vision. Generally, a feature point is a point in the image which can be characterized as follows: 1) it has a clear, preferably mathematically well-founded, definition; 2) it has a well-defined position in image space; 3) the local image structure around the feature point is rich in terms of local information contents, such that the use of feature points simplify further processing in the vision system; and 4) it is stable under local and global perturbations in the image domain, including deformations as those arising from perspective transformations as well as illumination/brightness variations, such that the feature points can be reliably computed with high degree of reproducibility.

In one embodiment, the two image frames, F₁ obtained at time T and F₂ obtained at time T+t, are depth frames (may also be referred to as depth maps). The two depth frames are processed and two 3D point clouds are subsequently obtained, which are labeled C₁ and C₂, respectively. Let C₁={p₁, . . . , p_{N}} denote the point cloud obtained from F₁, wherein a point cloud is basically a set of 3D points {p₁, . . . , p_{N}} where N is the number of points in the set and pᵢ=(xᵢ, yᵢ, zᵢ) is a triple of 3D coordinates of the i-th point in the set. Similarly, C₂={q₁, . . . , qₘ} is used to denote the point cloud obtained from F₂. It is contemplated that various image processing techniques can be utilized to process the frames obtained at time T and T+t in order to obtain their respective point clouds without departing from the spirit and scope of the present disclosure.

Upon receiving C₁ and C₂ at steps 102A and 102B, steps 102A and 102B each finds a point among C₁ and C₂, respectively, as the origin. In one embodiment, the centers of mass of point clouds C₁ and C₂ are used as the origins. More specifically, the center of mass of a point cloud is the average of the points in the cloud. That is, the center of mass of C₁ and the center of mass of C₂ are calculated as follows:

$$c {m}_{1} = \frac{1}{N} {\sum }_{i = 1}^{N} {p}_{i} , c {m}_{2} = \frac{1}{M} {\sum }_{i = 1}^{M} {q}_{i}$$

Once the centers of mass of the point clouds C₁ and C₂ are defined, the origins of the point clouds C₁ and C₂ are moved into the centers of mass. More specifically: pᵢ→pᵢ−cm₁ and qⱼ→qⱼ−cm₂.

Steps 104A and 104B subsequently construct 2D grids for the point clouds C₁ and C₂. In one embodiment, a 2D grid is constructed for a point cloud as a matrix G based on spherical representation, i.e., (r, θ, φ), wherein the conversion between spherical and Cartesian coordinates systems is defined as:

$$\{ \begin{matrix} r = \sqrt{{x}^{2} + {y}^{2} + {z}^{2}} \\ θ = arccos ( \frac{z}{\sqrt{{x}^{2} + {y}^{2} + {z}^{2}}} ) = arc tg ( \frac{\sqrt{{x}^{2} + {y}^{2}}}{z} ) \\ ϕ = arc tg ( \frac{y}{x} )\end{matrix}$$

More specifically, suppose a 2D grid having m rows and n columns is constructed for point cloud C₁. Let us define a subspace S_{i, j} where 0≦i≦m and 0≦j≦n. It is noted that since r>0, 0°≦θ≦90°, and 0°≦φ≦360°, S_{i, j} is therefore limited by

$$\frac{( i - 1 ) π}{m} < θ < \frac{i π}{m} and \frac{2 ( i - 1 ) π}{n} < ϕ < \frac{2 iπ}{n} .$$

Now let C_{1, i, j}={p′₁, . . . , p′ₖ} be a subset of points from C₁ within subspace S_{i, j}, the value in the (i, j) cell of the matrix G is calculated as:

$${g}_{i , j} = \frac{1}{k} {\sum }_{i = 1}^{k} {r}_{i}^{′}$$

Where r′ᵢ is the corresponding distance of point from the origin of C₁. It is contemplated that the 2D grid for point cloud C₂ is constructed in the same manner in step 104B.

Once the 2D grids for point clouds C₁ and C₂ are constructed, steps 106A and 106B start to find feature point candidates. While there are some methods available for finding feature point candidates, such methods are applicable only for finding correspondences between high-quality images having a very small level of noise. In cases where the 3D cameras utilized to provide the 3D frames have a considerable level of noise (e.g., due to technical limitations and/or other factors), existing methods fail to work effectively. Furthermore, if noise removing filters (e.g., Gaussian filters or the like) have been applied, very smooth images are produced which cannot be handled well by any of the existing methods. Steps 106A and 106B in accordance with the present disclosure therefore each utilizes a process capable of finding feature points on smoothed surfaces.

To illustrate this process, let us define a coordinate system (u, v) for the 2D grid and a function Q(u, v) on this grid in such a way that Q(u, v) is defined only in integer points. That is, u=i, v=j, where 0≦i≦m, 0≦j≦n, and Q(i, j)=g_{i, j}. Now, for each point on a 2D grid, utilizing least mean squares and/or other surface fitting processes, we can find the quadric surface QS(u, v) that approximates Q(u, v) at this point and its neighborhood of a small radius (e.g., about 5 to 10 neighboring points). In one embodiment, QS(u, v) is expressed as:

QS(u, v)=a₁u²+2a₂uv+a₃v²+a₄u+a₅v+a₆

Where u and v are the coordinates on the 2D grid and the values of coefficients aᵢ are determined based on surface fitting.

Mathematically, the quadratic form of the quadric surface, QS(u, v), is represented by the matrix:

$$W = ( \begin{matrix}{a}_{1} & {a}_{2} \\ {a}_{2} & {a}_{3}\end{matrix} ) ,$$

and the principal curvatures of such a quadric surface are determined by the eigenvalues of the matrix W. In accordance with the present disclosure, a point (u, v) on a 2D grid is considered as a feature point candidate in steps 106A and 106B if and only if: 1) QS(u, v) is paraboloid (elliptic or hyperbolic); and 2) (u, v) is the critical point of the surface (extremum or inflection).

While it is understood that various methods may be utilized to determine whether QS(u, v) is paraboloid and whether (u, v) is the critical point of the paraboloid, the following formula is used in one embodiment to find the coordinates of a critical point of a paraboloid:

$$( \begin{matrix}{u}_{c} \\ {v}_{c}\end{matrix} ) = - \frac{1}{2} {W}^{- 1} ( \begin{matrix}{a}_{4} \\ {a}_{5}\end{matrix} ) ,$$

wherein due to the quantization of the coordinates (u, v) on the 2D grid, (u, v) is deemed the critical point according to the quadratic surface QS(u, v) if and only if (u_{c}−u)²+(v_{c}−v)²<eps for a certain threshold eps (e.g., eps=1).

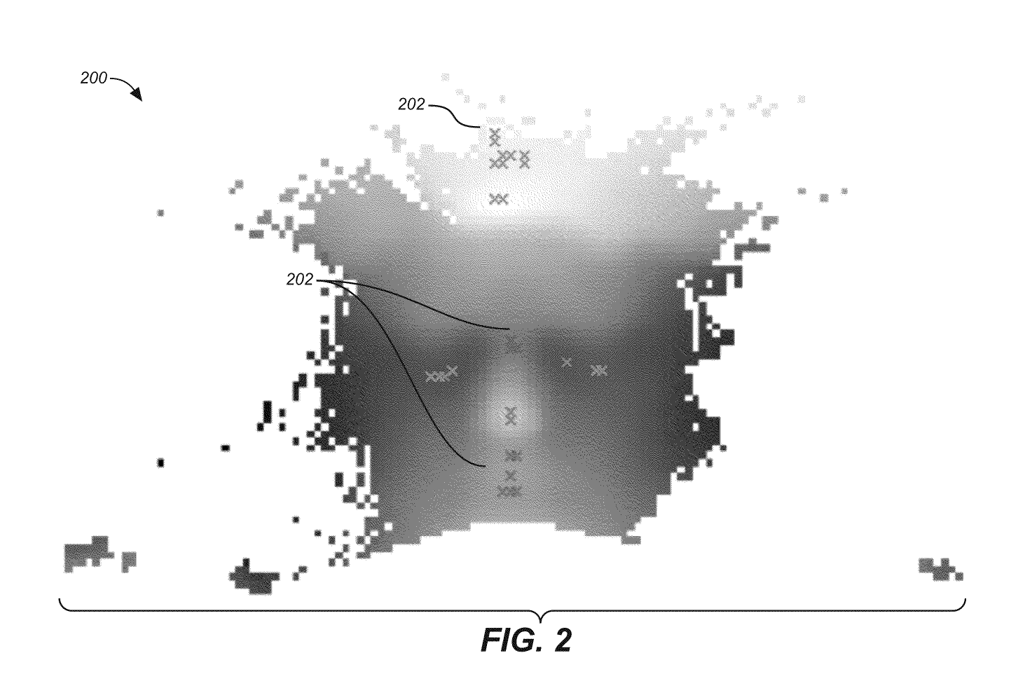

FIG. 2 is an illustration depicting a 2D grid 200 with the identified feature point candidates 202. The 2D grid 200 is constructed based on a 3D image frame of a head in this exemplary illustration. Once the 2D grid 200 is constructed, the feature point candidates 202 can be identified utilizing the process described above.

It is understood that the process of identifying the feature point candidates is performed by both steps 106A and 106B for two image frames obtained at different times. Once this process is completed for both frames, two sets of feature point candidates, denoted as FP₁ and FP₂, and their corresponding eigenvalues, are obtained. The goal of the rest of the method 100 is to find the appropriate correspondence between these two sets of points (which are of different sizes in general case) in 2D.

Once again, while there are some methods available for finding correspondence between feature points, such methods work only in conditions of small motions between frames. Steps 108 through 112 in accordance with the present disclosure are utilized to find correspondence between feature points without these shortcomings.

Prior to step 108, optionally, if we can obtain some knowledge about approximate nature of the motion in step 114, then we can obtain a motion prediction function A: R²→R² and process the reset of the method steps based on A(FP₁) instead of FP₁. The prediction function A can be obtained, for example, if correspondences between two or more points are well established. For instance, if certain feature points (e.g., on the nose or the like) are identified in both steps 106A and 106B, and correspondence between these points can be readily established, a motion prediction function A can therefore be obtained based on such information. However, if no knowledge about approximate nature of the motion is available, then the prediction function A is simply set as an identity function, i.e., A(FP₁)=FP₁. It is understood that step 114 is an optional step and the notations of A(FP₁) and FP₁ are used interchangeably in the steps 108 through 112, depending on whether the optional step 114 is performed.

Step 108 is then utilized to find initial correspondence between FP₁ and FP₂. That is, for any point, afp ∈ A(FP₁), find the most “similar” feature point bfp ∈ FP₂ such that ∥afp−bfp∥<nr(t), where nr(t) is a threshold neighborhood radius value. In accordance with the present disclosure, the more time t between the frames obtained at time T and T+t, the greater the threshold value nr(t). In one embodiment, a linear function nr(t)=nr₀+nr₁×t with nr₁>0 is defined. It is contemplated, however, that nr(t) is not limited to a linear function definition.

To further clarify the term “similarity” described above, in the case of comparing afp and bfp, it is the distance between their corresponding vectors of two eigenvalues. That is, the less distance, the more similar are the feature points. More specifically, if there exist more than one bfp for a particular afp and nr(t), the one that is the most similar is selected. On the other hand, if there is only one bfp for a particular afp and nr(t) then the notion of “similarity” does not need to apply. Furthermore, if no bfp from FP₂ in the neighborhood of the radius nr(t) of the point afp is found, then we can consider that for afp there is no correspondent point from FP₂. Based on these rules, step 108 processes each point A(FP₁) trying to find the most similar point from bfp ∈ FP₂. The corresponding pairs identified in this manner are then provided to step 110 for further processing.

Step 110 further refines the corresponding pairs identified in step 108. Refinement is needed because not all corresponding pairs identified in step 108 contain points that are truly the same point on the object (i.e., false-positive identifications are possible in step 108). In addition, the coordinate of FP usually are computed with some level of noise. Therefore, step 110 is needed to refine the initial list of corresponding pairs to clear out the pairs that are not consistent with real rigid motion.

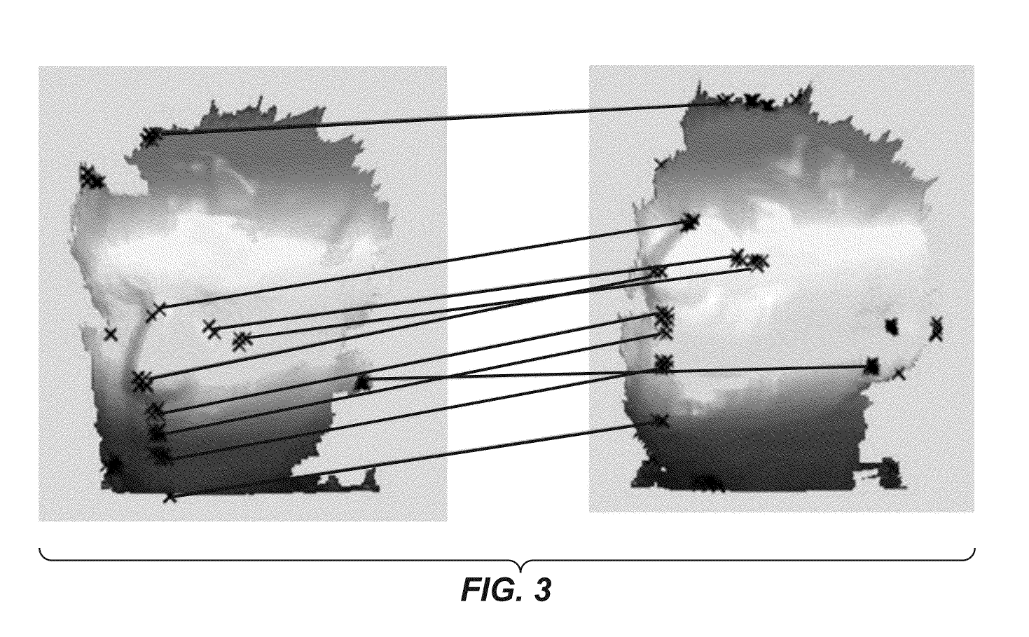

It is contemplated that various techniques may be utilized to refine the initial list. For instance, the technique referred to as RANdom SAmple Consensus, or RANSAC, is described in: Random Sample Consensus: A Paradigm for Model Fitting with Applications to Image Analysis and Automated Cartography, Martin A. Fischler et al., Comm. of the ACM 24 (6): 381-395 (June 1981), which is herein incorporated by reference in its entirety. FIG. 3 is an illustration depicting the refined correspondence between exemplary FP₁ and FP₂ shown on 2D grid of the rigid object.

Upon completion of step 110, a list of H correspondence pairs are obtained. Step 112 then tries to find rigid object motion and to provide 3D object registration based on the list of correspondence pairs. More specifically, by definition, each of the point in a given correspondence pair is a 2-element vector of integers (u, v). Step 112 therefore first converts the integer coordinates (u, v) to spherical coordinates as follows:

$$\{ \begin{matrix}r = {g}_{u , v} \\ θ = \frac{( u - 1 ) π}{m} \\ ϕ = \frac{2 ( v - 1 ) π}{n}\end{matrix}$$

Subsequently, the spherical coordinates are converted to Cartesian coordinates as follows:

$$\{ \begin{matrix}x = r sin θ cos ϕ \\ y = r sin θ sin ϕ \\ z = r cos θ\end{matrix}$$

Two sets of points in 3D can now be constructed in Cartesian coordinate system. More specifically, CR₁={pᵢ₁, . . . , p_{iH}}, which is a subset of C₁, and CR₂={qⱼ₁, . . . , q_{jH}}, which is a subset of C₂. Furthermore, the correspondence between the points in these two sets is defined as follows: for all e=1 . . . H, the point pᵢₑ corresponds to the point qⱼₑ.

It is noted that the two sets of points, CR₁ and CR₂, have the same cardinality with established correspondence between the points. Once the two sets of points are constructed, step 112 can use any fitting techniques to find the best orthogonal transformations between these sets by means of least squares. For instance, the technique described in: Least-Squares Fitting of Two 3-D Point Sets, K. S. Arun et al., IEEE Transactions on Pattern Analysis and Machine Intelligence, pp. 698-700 (1987), which is herein incorporated by reference in its entirety, can be used to find the best orthogonal transformation between CR₁ and CR₂.

It is contemplated that while the results obtained in step 112 can be reported as the output of the overall method 100, the results can be further improved in certain situations (e.g., due to inaccurate positions of FP, insufficient number of FP, incorrect correspondence pairs or the like). For instance, in one embodiment, an optional step 116 is utilized to improve the registration results obtained in step 112.

More specifically, let R(C₁) denote the 3D point cloud after applying transform R on set C₁. R can be improved utilizing techniques such as Iterative Closest Point (ICP) or Normal Distribution Transform (NDT) processes. Applying techniques such as ICP or NDT is beneficial in this manner because the point cloud R(C₁) and the point cloud C₂ are already almost coincided. In addition, motion between R(C₁) and C₂ can be estimated using all number of the point clouds, not only limited to certain feature points, to further improving accuracy. Once the best motion between R(C₁) and C₂, denoted as S, is obtained, the resulting motion with improved accuracy can be obtained as the superposition S×R.

It is contemplated that the method in accordance with the present disclosure is advantageous particularly when the two frames being processed are captured far apart in terms of time, the fast moving object is being captured, the camera is moving/shaking relative to the captured object or the object is captured by different 3D cameras with unknown correspondence between their coordinate systems. In addition, the method in accordance with the present disclosure is capable of finding feature points on smoothed surfaces and also finding correspondence between such feature points even when large motion is present. The ability to obtain orthogonal transformation between the rigid object captured at time T and T+t in accordance with the present disclosure can be utilized to find out many useful characteristics of the rigid object of interest.

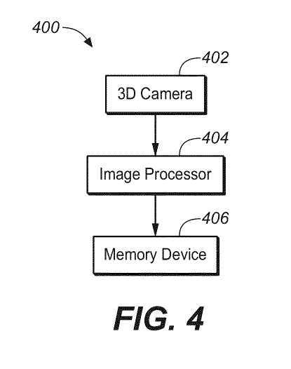

Referring to FIG. 4, a block diagram illustrating a system 400 for registration of two or more three-dimensional (3D) images is shown. In one embodiment, one or more 3D cameras 402 are utilized for capturing 3D images. The images captured are provided to an image processor 404 for additional processing. The image processor 404 includes a computer processor in communication with a memory device 406. The memory device 406 includes a computer-readable device having computer-executable instructions for performing the method 100 as described above.

It is to be understood that the present disclosure may be conveniently implemented in forms of a software package. Such a software package may be a computer program product which employs a computer-readable storage medium including stored computer code which is used to program a computer to perform the disclosed function and process of the present invention. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions. It is also understood that the 3D registration system or some portion of the system may also be implemented as a hardware module or modules (using FPGA, ASIC or similar technology) to further improve/accelerate its performance.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for registration of three-dimensional (3D) image frames, the method comprising:
receiving a first point cloud representing a first 3D image frame obtained at a first time instance and a second point cloud representing a second 3D image frame obtained at a second time instance;
locating a first origin for the first point cloud;
locating a second origin for the second point cloud;
constructing a first two-dimensional (2D) grid for representing the first point cloud, wherein the first 2D grid is constructed based on spherical representation of the first point cloud and the first origin;
constructing a second 2D grid for representing the second point cloud, wherein the second 2D grid is constructed based on spherical representation of the second point cloud and the second origin;
identifying a first set of feature points based on the first 2D grid constructed;
identifying a second set of feature points based on the second 2D grid constructed;
establishing a correspondence between the first set of feature points and the second set of feature points based on a neighborhood radius threshold; and
determining an orthogonal transformation between the first 3D image frame and the second 3D image frame based on the correspondence between the first set of feature points and the second set of feature points.

2. The method of claim 1, wherein the first and second origins for the first and second point clouds are centers of mass of the first and second point clouds, respectively.

3. The method of claim 1, wherein a given point on a 2D grid is identified as a feature point if and only if: that given point is a critical point, and a quadric surface that approximates a value in the 2D grid at that given point is a paraboloid.

4. The method of claim 1, wherein the neighborhood radius threshold is dynamically determined based on a time difference between the first time instance and the second time instance.

5. The method of claim 4, wherein the neighborhood radius threshold is proportional to the time difference between the first time instance and the second time instance.

6. The method of claim 1, further comprising:
refining the correspondence between the first set of feature points and the second set of feature points established based on the neighborhood radius threshold utilizing a random sample consensus process.

7. The method of claim 1, wherein determining an orthogonal transformation between the first 3D image frame and the second 3D image frame further comprises:
converting each feature point in the first set of feature points with established correspondence to a point in Cartesian coordinate;
converting each feature point in the second set of feature points with established correspondence to a point in Cartesian coordinate;
applying a fitting process to determine the orthogonal transformation between the feature points in the first and second set of feature points.

8. The method of claim 1, further comprising:
applying a motion prediction for the first set of feature points prior to establishing a correspondence between the first set of feature points and the second set of feature points.

9. A method for registration of three-dimensional (3D) image frames, the method comprising:
receiving a first point cloud representing a first 3D image frame obtained at a first time instance and a second point cloud representing a second 3D image frame obtained at a second time instance;
locating a first origin for the first point cloud;
locating a second origin for the second point cloud;
constructing a first two-dimensional (2D) grid for representing the first point cloud, wherein the first 2D grid is constructed based on spherical representation of the first point cloud and the first origin;
constructing a second 2D grid for representing the second point cloud, wherein the second 2D grid is constructed based on spherical representation of the second point cloud and the second origin;
identifying a first set of feature points based on the first 2D grid constructed;
identifying a second set of feature points based on the second 2D grid constructed;
establishing a correspondence between the first set of feature points and the second set of feature points based on a neighborhood radius threshold, wherein the neighborhood radius threshold is proportional to a time difference between the first time instance and the second time instance; and
determining an orthogonal transformation between the first 3D image frame and the second 3D image frame based on the correspondence between the first set of feature points and the second set of feature points.

10. The method of claim 9, wherein the first and second origins for the first and second point clouds are centers of mass of the first and second point clouds, respectively.

11. The method of claim 9, wherein a given point on a 2D grid is identified as a feature point if and only if: that given point is a critical point, and a quadric surface that approximates a value in the 2D grid at that given point is a paraboloid.

12. The method of claim 9, further comprising:
refining the correspondence between the first set of feature points and the second set of feature points established based on the neighborhood radius threshold utilizing a random sample consensus process.

13. The method of claim 9, wherein determining an orthogonal transformation between the first 3D image frame and the second 3D image frame further comprises:
converting each feature point in the first set of feature points with established correspondence to a point in Cartesian coordinate;
converting each feature point in the second set of feature points with established correspondence to a point in Cartesian coordinate;
applying a fitting process to determine the orthogonal transformation between the feature points in the first and second set of feature points.

14. The method of claim 9, further comprising:
applying a motion prediction for the first set of feature points prior to establishing a correspondence between the first set of feature points and the second set of feature points.

15. A computer-readable device having computer-executable instructions for performing a method for registration of three-dimensional (3D) image frames, the method comprising:
receiving a first point cloud representing a first 3D image frame obtained at a first time instance and a second point cloud representing a second 3D image frame obtained at a second time instance;
locating a first origin for the first point cloud;
locating a second origin for the second point cloud;
constructing a first two-dimensional (2D) grid for representing the first point cloud, wherein the first 2D grid is constructed based on spherical representation of the first point cloud and the first origin;
constructing a second 2D grid for representing the second point cloud, wherein the second 2D grid is constructed based on spherical representation of the second point cloud and the second origin;
identifying a first set of feature points based on the first 2D grid constructed;
identifying a second set of feature points based on the second 2D grid constructed;
establishing a correspondence between the first set of feature points and the second set of feature points based on a neighborhood radius threshold; and
determining an orthogonal transformation between the first 3D image frame and the second 3D image frame based on the correspondence between the first set of feature points and the second set of feature points.

16. The computer-readable device of claim 15, wherein the first and second origins for the first and second point clouds are centers of mass of the first and second point clouds, respectively.

17. The computer-readable device of claim 15, wherein a given point on a 2D grid is identified as a feature point if and only if: that given point is a critical point, and a quadric surface that approximates a value in the 2D grid at that given point is a paraboloid.

18. The computer-readable device of claim 15, wherein the neighborhood radius threshold is proportional to the time difference between the first time instance and the second time instance.

19. The computer-readable device of claim 15, wherein determining an orthogonal transformation between the first 3D image frame and the second 3D image frame further comprises:
converting each feature point in the first set of feature points with established correspondence to a point in Cartesian coordinate;
converting each feature point in the second set of feature points with established correspondence to a point in Cartesian coordinate;
applying a fitting process to determine the orthogonal transformation between the feature points in the first and second set of feature points.

20. The computer-readable device of claim 15, further comprising:
applying a motion prediction for the first set of feature points prior to establishing a correspondence between the first set of feature points and the second set of feature points.
